(19) United States
(12) Patent Application Publication
(10) Pub. No.: US 2006/0152476 A1
(43) Pub. Date: Jul. 13, 2006

(54) Method of driving a foil display screen and device having such a display screen

(76) Inventors: Gerardus Van Gorkom, Eindhoven (NL); Siebe Tjerk De Zwart, Eindhoven (NL); Antonius Hendricus Maria Holtslag, Eindhoven (NL); William Peter Mechtildis Marie Jans, Eindhoven (NL); Sebastiaan De Bont, Eindhoven (NL)

Correspondence Address: Philips Electronics North America Corporation;Corporate Patent Counsel, PO Box 3001, Briarcliff Manor, NY, 10510, US

(21) Appl. No.: 10/507,774

(22) PCT Filed: Feb. 18, 2003
(86) PCT No.: PCT/IB03/00631

§ 371 Date: Sep. 14, 2005

(30) Foreign Application Priority Data
Mar. 20, 2002 (EP) 02076091.4

(51) Int. Cl. G09G 3/34

(52) U.S. Cl. 345/108

(57) ABSTRACT

The invention relates to a method of controlling a display screen, particularly a foil display built up of a number of lines, the display screen comprising at least one light source, a movable element, and selection means for locally bringing the movable element into contact with the light source, in which the selection means comprise row and column electrodes and means for applying control voltage signals to the invention also relates to a display source, a movable element, and selection means for locally bringing the movable element into contact with the light source, in which the selection means comprise row and column electrodes and means for applying control voltage signals to the row and column electrodes. Because of a minimum switching time of pixels, not all pixels, i.e. lines can be activated immediately when the display screen is addressed line by line. To avoid this problem, the invention provides a novel addressing method comprising the step of addressing a group of lines or a part of a group of lines while the light source is switched off, followed by a step of illuminating the display screen for a predetermined interval by switching on the light source.

The invention relates to a method of driving a display screen built up of a group of lines, particularly a foil display screen comprising at least one light source, a movable element, and selection means for locally bringing the movable element into contact with the light source, in which the selection means comprise row and columns electrodes, and means for applying control voltage signals to the row and column electrodes.

The invention also relates to a device having such a display screen comprising at least one light source, a movable element, and selection means for locally bringing the movable element into contact with the light source, in which the selection means comprise row and column electrodes, and means for applying control voltage signals to the row and column electrodes.

A device having a display screen of the type described in the opening paragraph is known, for example, from U.S. Pat. No. 4,113,360. This document discloses a display screen comprising a first plate which is made of a fluorescent material in which light is generated and trapped during operation, and a second plate which is spaced apart from the first plate and in which a movable element in the form of a membrane is incorporated between the two plates.

By applying control voltage signals to drivable electrodes on the first and the second plate, the movable element can be locally brought into contact with the first plate, or the contact can be interrupted accordingly. At locations where the movable element is in contact with the first plate, light can be passed through from the first plate. This provides the possibility of displaying an image. If the movable element is not in “active” contact with the light source, it is in “passive” contact with the second plate.

In this known application, the image which is to be displayed is written line by line, while the row and column electrodes are driven row by row by means of suitable control voltage signals, or addressed in dependence upon the image information to be displayed on said line. As an addressing method, the method referred to as “interlace scan” or “progressive scan” can be used. A characteristic feature of an image built up of rows and columns and comprising a large number of pixels is that each pixel requires a minimum time to be switched by a suitably supplied control voltage signal. This minimum switching time is given by the fact that a pixel is in passive contact with the second plate in the initial situation, and that, after supplying a suitable control voltage signal, it should be brought into “active” contact with the first plate in order to transmit light.

To displace the pixel reliably and steadily from one position to the other, a given minimum switching or addressing time is required.

Due to this minimum switching time, it may occur that not all pixels or lines are activated simultaneously when addressing the display screen line by line. This phenomenon notably occurs, or is at least visible, if the display screen is to be written with picture information of a uniform grey level. Due to the switching time of the separate pixels and the fact that the brightness of the separate pixels on one line is also dependent on the number of pixels, it is possible that some lines in a uniformly written grey image have a brightness which deviates from the brightness of the adjacent lines, which leads to an unacceptable visual distortion.

It is an object of the present invention to provide a novel drive or addressing method obviating the above-mentioned phenomenon.

According to the invention, the method is therefore characterized in that, while a light source is switched off, the group or a part of the group of lines is written line by line with the image to be displayed, whereafter the light source is switched on for a given time interval.

By driving all lines or part of the lines line by line with suitable control voltage signals and subsequently switching on the light source for a given time interval, all of the driven pixels are illuminated simultaneously so that the same grey level is displayed throughout the driven image. Pixels or lines in the image with a different brightness than the adjacent pixels or lines are thereby prevented.

According to the invention, the above-mentioned favorable effect is even enhanced in that, prior to the step of writing the image, the group or a part of the group of lines is jointly switched on or off.

In a particular aspect of the method according to the invention, this method is characterized in that the light source is switched off and/or the image is erased after the given time interval. The lines are thus erased simultaneously so that no perturbations in the form of persistent lines or pixels are produced in the black image.

More particularly, the method according to the invention is characterized in that the light source is switched on for a varying number of time intervals while consecutively driving the group or parts of the group of lines. Consequently, a plurality of grey levels can be imaged consecutively in the image, while in a particular aspect, the group or a part of the group of lines is driven color by color while using a plurality of light sources each emitting only one color.

As a solution to the above-mentioned problem, the display device according to the invention is characterized in that, while a light source is switched off, the selection means write the group or a part of the group of lines line by line with the image to be displayed and subsequently energize the light source for a given time interval.

In order to be able to drive the different pixels or lines color by color, a special embodiment of the display device is characterized in that it comprises a plurality of light sources each emitting only one color.

More particularly, the light sources can be rapidly switched on and off and may be formed as LEDs or as solid-state lasers.

An important aspect of the present invention is the use of light sources which do not continuously illuminate the foil screen and in which the image is displayed only after driving the relevant row and column electrodes, but in which the light sources can be switched on and off very rapidly for the purpose of rapid and simultaneous illumination of a large number of driven image lines.

According to the invention, the part of the group of lines may also comprise one line.

These and other aspects of the invention are apparent from and will be elucidated with reference to the embodiments described hereinafter.

In the drawings:

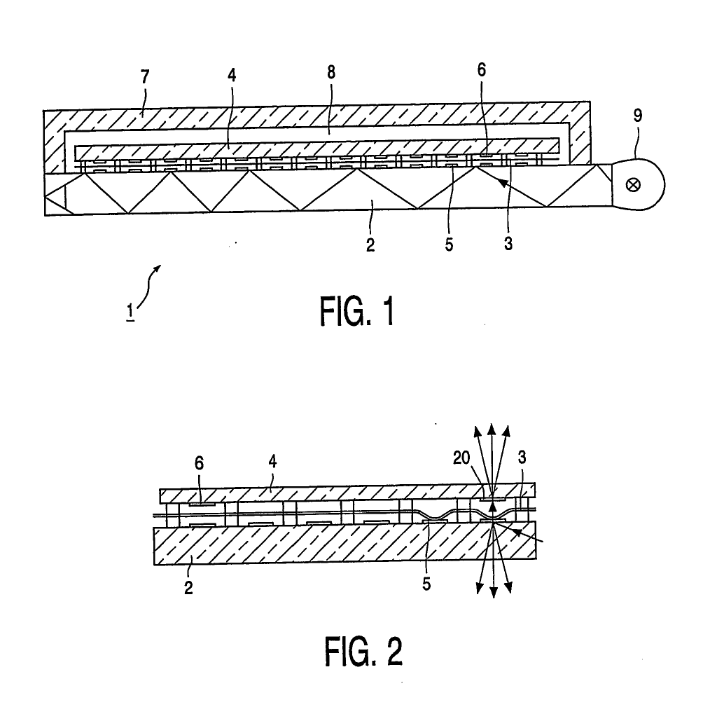

FIG. 1 shows an embodiment of a foil display screen;

FIG. 2 is a partial view of the foil display screen of FIG. 1;

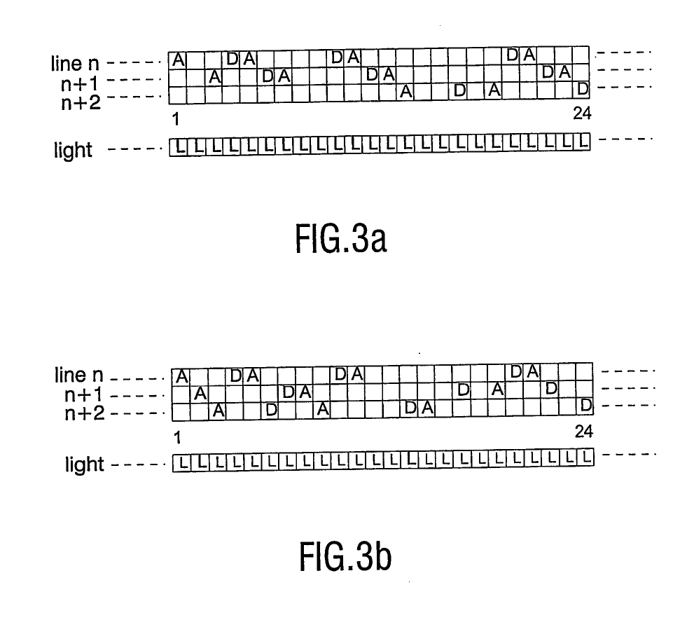

FIGS. 3a and 3b show two embodiments of drive modes in accordance with the state of the art of a foil display screen comprising row and column electrodes, as shown in FIGS. 1 and 2;

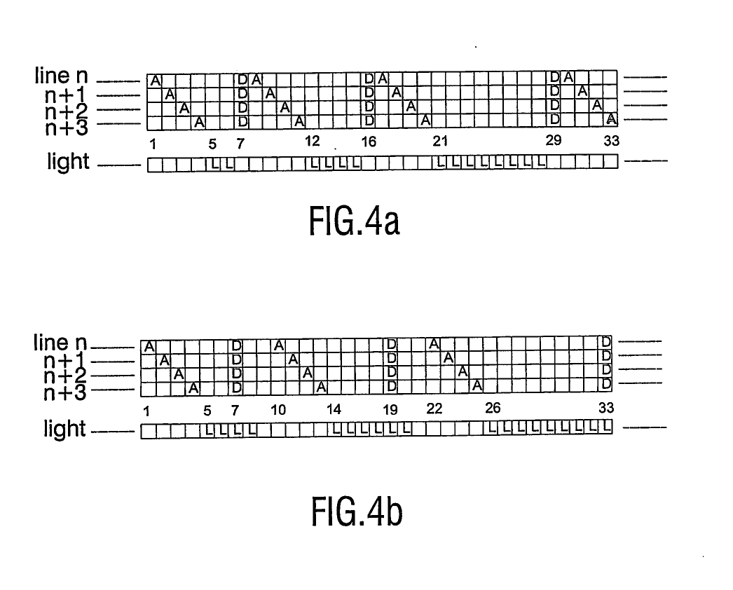

FIGS. 4a and 4b show two embodiments of the drive mode according to the invention of a foil display screen comprising row and column electrodes, as shown in FIGS. 1 and 2;

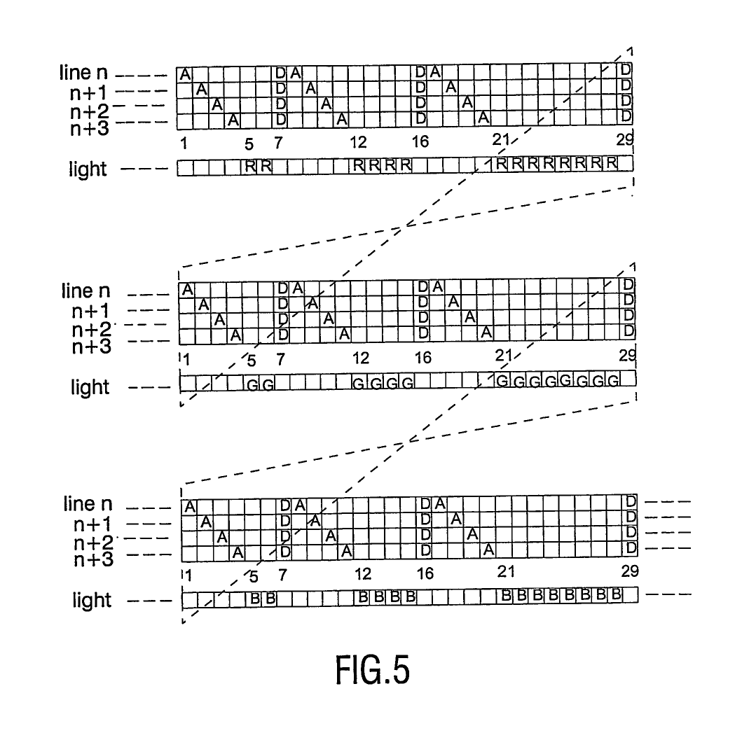

FIG. 5 shows an embodiment of a drive mode according to the invention of a foil display screen comprising row and column electrodes, as shown in FIGS. 1 and 2.

FIGS. 1 and 2 diagrammatically show an embodiment of a foil display screen. The foil display screen 1 comprises an optical waveguide, briefly referred to as light guide, 2, one side of which is provided with an energizable light source 9. Moreover, the foil display screen comprises a movable element 3 which is incorporated at some distance between the light guide 2 and a light-transmissive plate 4. The entire construction is covered or shielded by a light-transparent coating 7.

Electrodes 5 and 6 are positioned on both sides of the movable element 3, the electrodes 6 being provided on the surface of the light-transmissive plate 4 and the electrodes 5 being placed on the light guide 2. The electrodes 5 and 6 form a set of electrodes which are oriented at right angles (90°) with respect to each other. For example, the set of electrodes 5 constitutes the row electrodes and the set of electrodes 6 constitutes the column electrodes of the foil display screen.

By locally providing a voltage difference between the cross-oriented row and column electrodes 5 and 6, the movable element 3, which may be, for example a foil, can be brought into contact with the relevant electrode 5 on the light guide 2 or with the relevant electrode 6 on the light-transmissive plate 4 under the influence of the locally applied potential difference between the row and column electrodes 5 and 6.

The light transmitted by the light source 9 propagates through the light guide 2, with the light each time reflecting on the side walls of the light guide 2. The light transmitted by the light source is thus trapped in the light guide 2. At the location where the movable element 3 has come into contact with the electrode 5 and thus with the light guide 2 under the influence of a locally applied voltage difference between the electrodes 5 and 6, it is ensured that light trapped in the light guide 2 can emerge from the light guide 2 via the contact thus created and can thus leave the device, i.e. the foil display screen via the light-transmissive plate 4 and via the transparent coating 7. This phenomenon results in a luminescing pixel for the viewer.

It is thus possible to bring the movable element 3 into contact with either the relevant row electrode 5 or with the relevant column electrode 6 by rapidly and suitably driving the row and column electrodes 5 and 6 consecutively. In the first-mentioned situation, in which the movable element 3 is in contact with the electrode 6, no light can escape at the location of this pixel so that the relevant pixel cell is deactivated. In the last-mentioned case, in which the movable element 3 is in contact with an electrode 5 (as shown in FIG. 2), light can escape from the light guide via the pixel cell so that the relevant pixel is activated.

The examples shown in FIGS. 3a and 3b relate to drive modes in accordance with the state of the art of a matrix field, built up of row and column electrodes, of a known foil display screen as shown in FIGS. 1 and 2. When writing the prior-art foil display screen with information, the foil display screen is continuously illuminated from behind by the lamp 9 (see FIG. 1). In this case, the information to be displayed is written line by line in the foil display screen, in which each pixel in the display screen, formed by the matrix of crossing row and column electrodes, luminesces or does not luminesce in dependence upon the image to be displayed, as shown in FIG. 2, by applying suitable control voltage signals to the different row and column electrodes.

As is shown in FIGS. 3a and 3b, a group of lines is alternately written or activated with information (denoted by the character “A”), or deactivated or erased (denoted by the character “D”) by means of suitable drive signals. When the lines n, n+1 and n+2 are being driven (written and erased), they (the pixels of each line) are illuminated continuously, as is denoted by the characters “L”.

Each display screen pixel requires a given minimum switching or addressing time for bringing the relevant pixel from a deactivated position “D” to an activated position “A”. Due to this minimum switching time, the brightness of the individual pixels on one line may be different, which phenomenon notably occurs when the display screen is to be written with picture information of a uniform grey level. These differences of grey values or brightness may lead to an unacceptable visual distortion in the image.

It is an object of the present invention to provide a method which is suitable for driving or addressing the pixels in a foil display screen built up of rows and columns, of which a first embodiment is shown in FIGS. 4 and 4b.

In the first embodiment of the addressing method according to the invention, shown in FIG. 4a, a line n is addressed (see code “A”) at the instant t=1, whereafter the line n+1 is addressed at instant t=2, and subsequently the line n+2 is addressed at the instant t=3, whereafter the last line n+3 of the relevant group of lines of which the foil display screen is built up is addressed at the instant t=4, as is denoted by the code “A”. Subsequently, the lamp L is activated for two periods of time (up to and including 6 at the instant t=5 so that the image information in the lines n to n+3 can be projected for the viewer. At the instant t=7, all lines n, n+1, n+2, n+3 of the group of lines are deactivated or erased (denoted by “D”) whereafter the next addressing cycle starts at the instant t=8. While the light source is switched off, the lines n, n+1, n+2 and n+3 are consecutively written with new (possibly modified) information at the instants t=8, t=9, t=10 and t=11. At instant t=12, the light source is switched on again (denoted by the sequence “LLLL”) for four periods of time (t=12 up to and including t=15), whereafter the lines n, n+1, n+2, n+3 constituting the partial group are simultaneously deactivated at the instant t=16.

A new addressing cycle commences at the instant t=17 up to and including instant t=20, whereafter the light source is re-energized for the period (t=21 to t=28) for the purpose of illuminating the addressed lines.

This group-wise drive of one or more line electrodes of the display screen when the light source is switched off can be performed sequentially until the complete display screen has been driven. Since the different lines are driven when the light source is switched off and are subsequently illuminated for a given time interval when the light source is switched on, all of the driven pixels are simultaneously illuminated so that the same grey level is displayed throughout the driven image. It is thereby prevented that pixels or lines in the image are displayed with a different brightness than the adjacent pixels or lines.

The advantage of simultaneous erasure at the instants t=7, t=16 and t=29 when the lamp is switched off (see FIG. 4a) is that the black image thus created is not perturbed by persistent lines or pixels.

Since, viewed in the time base of FIG. 4a (and also of FIG. 4b), the driven group of lines n, n+1, n+2 and n+3 is illuminated in a varying period of time (an increasing period of time in this embodiment), a plurality of grey levels can be consecutively imaged.

In the other embodiment shown in FIG. 4b, the light source is driven for a given time interval after driving the different lines one by one, which lines form part of a group of image lines, while the group of lines n, n+1, n+2, n+3 is deactivated or erased simultaneously during this illumination period. Compare the instants t=7, t=19 and t=33 in FIG. 4b.

This also prevents perturbations and distortions of persistent lines or pixels.

FIG. 5 shows another embodiment of driving image lines according to the invention, in which, viewed with respect to time, the group of image lines n, n+1, n+2 and n+3 is again activated (see the marks “A”) during consecutive instants and when the light source is switched off at the instants t=1 to t=4 inclusive, whereafter a light source transmitting a specific color, here the color red R, is activated during the period t=5 to t=6. At the instant t=7, the red light source is switched off while the image lines n, n+1, n+2 and n+3 are simultaneously deactivated or erased. Subsequently, the group of lines is again addressed line by line during consecutive instants t=8 up to and including t=11, whereafter the red light source is activated at the instant t=12 during a time interval having a different duration (here a longer duration, namely four units of time), up to and including the instant t=15. At the instant t=16, the red light source is switched off again while the group of image lines n to n+3 inclusive is simultaneously deactivated or erased.

During the instants t=17 up to and including t=20, the group of image lines n to n+3 inclusive is again addressed line by line, whereafter the addressed image line is illuminated at the instant t=21 up to and including instant t=28 (again an increasing duration) by the red light source which has been switched on. At the instant t=29, the red light source is switched off while the group of images lines n to n+3 is simultaneously erased. Subsequently, a new addressing cycle commences, whereafter a green light source is activated after the group of image lines n to n+3 inclusive has been addressed line by line. Here again, the green light source is activated during intervals with a varying (here increasing) duration during the consecutive addressing cycli. After the green light source has been switched off, the group of lines is simultaneously deactivated (erased), as is denoted by “D”.

Subsequently, the addressing cycle is repeated for the same group of image lines n to n+3, in which the other elementary color of blue is now used. Consequently, a group of image lines is consecutively addressed with the information to be displayed and consecutively illuminated with different light sources each time after the group of image lines has been written, each light source emitting one of the elementary colors of red, green and blue during a time interval.

1. A method of driving a display screen built up of a group of lines, particularly a foil display screen comprising at least one light source, a movable element, and selection means for locally bringing the movable element into contact with the light source, in which the selection means comprise row and column electrodes, and means for applying control voltage signals to the row and column electrodes, characterized in that, while a light source is switched off, the group or a part of the group of lines is written line by line with the image to be displayed, whereafter the light source is switched on for a given time interval.

2. A method as claimed in claim 1, characterized in that, prior to the step of writing the image, the group or part of the group of lines is jointly switched on or off.

3. A method as claimed in claim 1, characterized in that the light source is switched off after the given time interval.

4. A method as claimed in claim 1, characterized in that the image is erased after the given time interval.

5. A method as claimed in claim 1, characterized in that the light source is switched on for a varying number of time intervals while consecutively driving the group or parts of the group of lines.

6. A method as claimed in claim 1, characterized in that the group or a part of the group of lines is driven color by color while using a plurality of light sources each emitting only one color.

7. A device having a display screen comprising at least one light source, a movable element, and selection means for locally bringing the movable element into contact with the light source, in which the selection means comprise row and column electrodes, and means for applying control voltage signals to the row and column electrodes, characterized in that, while a light source is switched off, the selection means write the group or a part of the group of lines line by line with the image to be displayed and subsequently energize the light source for a given time interval.

8. A display device as claimed in claim 7, characterized in that the device comprises a plurality of light sources each emitting only one color.

9. A display device as claimed in claim 7, characterized in that the light source or sources is or are light sources which can be rapidly switched on and off.

10. A display device as claimed in claim 9, characterized in that the light source or sources is or are formed as LEDs or as solid-state lasers.

11. A display device as claimed in claim 7, characterized in that the part of the group of lines comprises one line.
